(19) United States
(12) Patent Application Publication
(10) Pub. No.: US 2011/0125356 A1
(43) Pub. Date: May 26, 2011

(54) DRIVE CONTROL SYSTEM FOR A VEHICLE

(75) Inventor: Shigenori TAKAHASHI, Anjo-city (JP)

(73) Assignee: DENSO CORPORATION, Kariya-city (JP)

(21) Appl. No.: 12/952,860

(22) Filed: Nov. 23, 2010

(30) Foreign Application Priority Data
Nov. 24, 2009 (JP) 2009-265858

(51) Int. Cl. F16D 48/06; B60K 6/38

(52) U.S. Cl. 701/22; 180/65.22; 903/902

(57) ABSTRACT

A drive control system for a vehicle has a power train including an internal combustion engine, a transmission and wheels. In the power train, a motor-generator is provided as a drive power source between the transmission and the wheels. A clutch is provided between the transmission and the motor-generator. A control unit controls an operation state of the clutch to either a drive power transfer state or a drive power interruption state in correspondence to a location of failure, when a failure arises in the power train, which includes an engine system, a transmission system and a motor-generator system. The control unit further controls the clutch to the drive power interruption state when the failure arises in the engine system or the transmission system. The control unit controls the clutch to the drive power transfer state when the failure arises in the motor-generator system.

### CROSS REFERENCE TO RELATED APPLICATION

This application is based on and incorporates herein by reference Japanese Patent Application No. 2009-265858 filed on Nov. 24, 2009.

### FIELD OF THE INVENTION

The present invention relates to a drive control system for a vehicle, which includes an internal combustion engine and a motor-generator as drive power sources.

### BACKGROUND OF THE INVENTION

Hybrid vehicles are provided more and more recently to meet social demands for low fuel consumption and low exhaust emission. In one exemplary hybrid vehicle, which is on the market, an internal combustion engine and two motor-generators are coupled through a power dividing mechanism (for example, planetary gear set). The two motor-generators are a first motor-generator (first MG) and a second motor-generator (second MG), which are used primarily as electric power generators and a drive unit for driving wheels, respectively. Since the MG and an inverter for the MG need be provided in each of two systems in this hybrid vehicle, the drive system necessarily becomes large-sized and costs high.

JP 2002-160540A, for example, discloses to provide one clutch and one MG in a power train, which transfers the drive power of an engine to wheels through a transmission. The clutch is provided between the engine and the transmission. The MG is coupled to a differential gear provided between the transmission and the wheels.

It is possible to provide one MG and one clutch in a power train, which transfers the drive power of an engine to wheels through a transmission. The MG is coupled between the transmission and the wheels. The clutch is provided between the transmission and the MG.

Fail-safe operation is needed, when a failure (abnormality) arises in an engine system (for example, fuel system, air system and ignition system) or a transmission system (for example, transmission or hydraulic pressure control circuit). As the fail-safe operation, a vehicle travels in a limp-home travel mode (motor-driven travel mode) by driving the wheels by only the drive power of the MG while stopping the engine operation. If the clutch is in the engaged state (drive power transfer state), the drive power of the MG is used to not only drive the wheels but also drive the engine and the transmission. This increases loss of energy, lowers vehicle drive performance and increases electric power consumption. The failure also arises in a MG system (for example, MG or inverter) under a condition that the clutch is in the disengaged state (drive power interruption state). In this instance, the drive power of the engine cannot be transferred to the wheels and hence the vehicle cannot be driven in the limp-home travel mode.

### SUMMARY OF THE INVENTION

It is therefore an object of the present invention to provide a drive control system for a vehicle, which controls a clutch to appropriate states in correspondence to a location of failure when a failure arises in a power train of a vehicle.

According to the present invention, a drive control system for a vehicle has a power train including an internal combustion engine, a transmission and wheels. The drive control system further includes a motor-generator, a clutch and a control unit. The motor-generator is provided as a drive power source between the transmission and the wheels. The clutch is provided between the transmission and the motor-generator. The control unit is configured to control an operation state of the clutch to either a drive power transfer state or a drive power interruption state in correspondence to a location of failure when a failure arises in the power train, which includes an engine system having the engine, a transmission system having the transmission and a motor-generator system having the motor-generator.

Preferably, the control unit controls the clutch to the drive power interruption state when the failure arises in the engine system or the transmission system, and controls the clutch to the drive power transfer state when the failure arises in the motor-generator system.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a drive control system for a hybrid vehicle according to an embodiment of the present; and

FIG. 2 is a flowchart showing processing of a failure-time clutch control routine executed in the embodiment.

### DETAILED DESCRIPTION OF THE PREFERRED EMBODIMENT

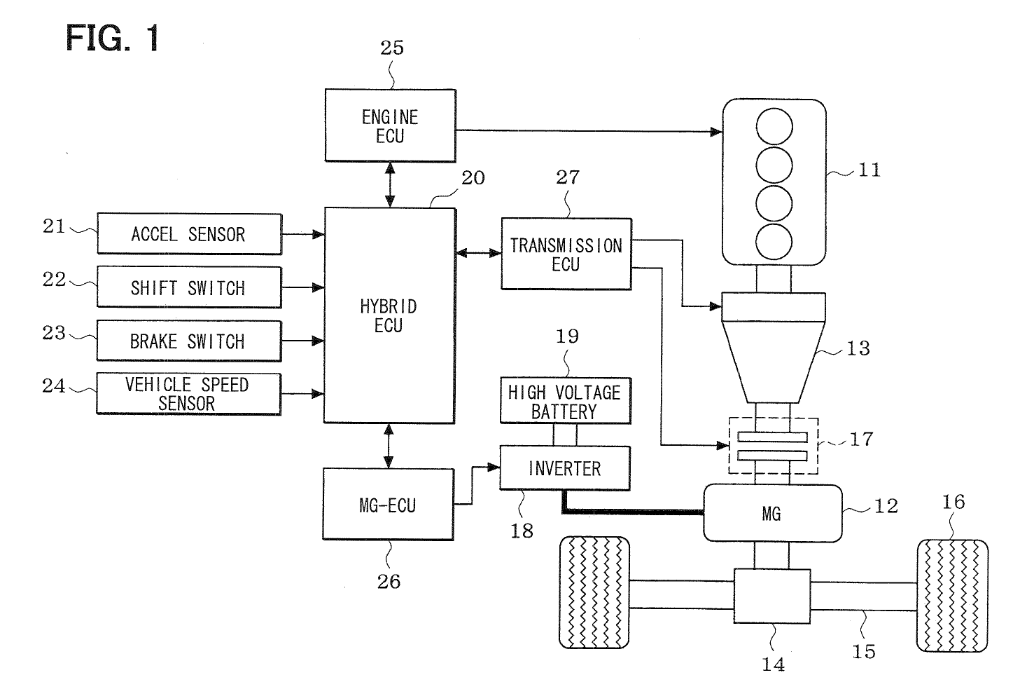

Referring first to FIG. 1, a drive control system for a hybrid vehicle has an internal combustion engine 11 and a motor-generator (MG) 12 as drive power sources of the hybrid vehicle. The engine 11 is coupled to a transmission 13 so that the drive power of an output shaft (crankshaft) of the engine 11 is transferred to the transmission 13. The drive power of an output shaft of the transmission 13 is transferred to wheels 16 through a differential gear set 14 and an axle shaft 15. The transmission 13 includes, for example, a torque converter and a hydraulically-operated transmission gears. The transmission 13 may be a multi-stage transmission type, in which a gear stage is selected from a multiple of gear stages, or a continuously variable transmission (CVT) type.

An output shaft of the MG 12 is coupled between the transmission 13 and the differential gear set 14 in a power train, which transfers the drive power of the engine 11 to the wheels 16, thereby to transfer the drive power. A clutch 17 is provided between the MG 12 and the transmission 13 thereby to control transfer of the drive power. The clutch 17 may either be a hydraulically-operated clutch or an electromagnetically-operated clutch. An inverter 18, which drives the MG 12, is connected to a high-voltage battery 19 so that the MG 12 receives and supplies electric power from and to the high-voltage battery 19 through the inverter 18, respectively.

A hybrid electronic control unit (hybrid ECU) 20 is a computer, which comprehensively controls the hybrid vehicle. The hybrid ECU 20 is configured to detect operation conditions of the vehicle based on output signals of an accelerator sensor 21, a shift switch 22, a brake switch 23, a vehicle speed sensor 24 and other sensors and switches. The accelerator sensor 21 detects an accelerator position (operation amount of an accelerator pedal). The shift switch 22 detects an operation position of a shift lever of the transmission 13. The brake switch 23 detects a braking operation. The vehicle speed sensor 24 detects a travel speed of the vehicle. The hybrid ECU 20 is connected to transmit and receive control signals and data signals to and from an engine ECU 25, a MG-ECU 26 and a transmission ECU 27. The engine ECU 25 is configured to control an operation of the engine 11. The MG-ECU 26 is configured to control an operation of the MG 12 by controlling the inverter 18. The transmission ECU 27 is configured to control the transmission 13 and the clutch 17. The ECUs 25 to 27 thus control the engine 11, the MG 12, the transmission 13 and the clutch 17 based on operation conditions of the vehicle.

For example, in a motor-driven travel range (travel start time or low fuel economy operation condition of the engine 11 such as a low load time), the clutch 17 is controlled to the drive power interruption state, in which its input side and the output side are disengaged. By thus maintaining the drive power interruption state, the transfer of the driver power from the engine 11 and the transmission 13 to the wheels 16 is interrupted. At this time, the engine 11 is maintained in the operation stop condition. The wheels 16 are driven by only the drive power of the MG 12 for vehicle travel.

In a normal travel range, the clutch 17 is controlled to the drive power transfer state, in which its input side and output side are engaged. By thus maintaining the drive power transfer state, the driver power is transferred from the engine 11 to the wheels 16 through the transmission 13, the clutch 17 and the like. At this time, the wheels 16 are driven by only the drive power of the engine 11 (engine-only travel) or by both drive powers of the engine 11 and the MG 12 (assist travel).

In a deceleration range, the clutch 17 is controlled the drive power interruption state so that the transfer of the drive power between the engine 11 and the wheels 16 is interrupted. The MG 12 is driven by the drive power of the wheels 16 to operate as an electric power generator. The MG 12 converts kinetic energy of the vehicle to electric power, which is restored (charged) to the high-voltage battery 19, thus performing a regenerative braking operation.

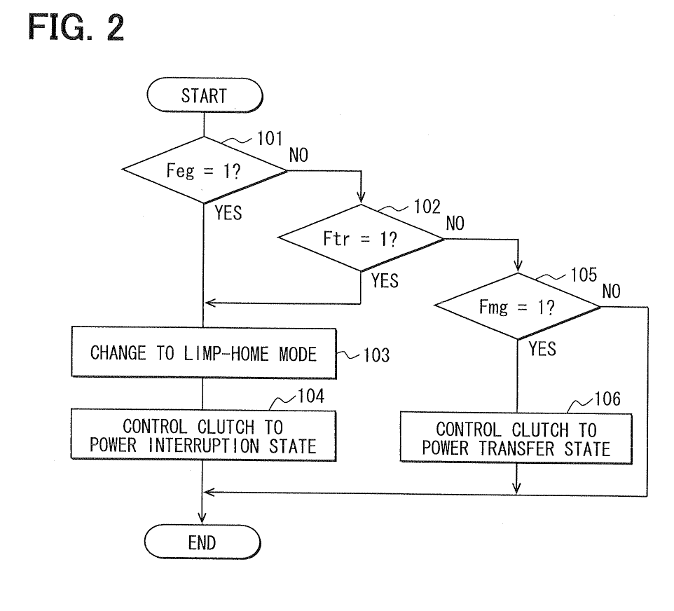

The hybrid ECU 20 is further configured to perform failure-time clutch control. The hybrid ECU 20 specifically controls the clutch 17 to either the drive power transfer state or the drive power interruption state in correspondence to location of failure (abnormality) thereby to control the clutch 17 to an appropriate state in correspondence to the location of the failure in the drive power transfer system, when any failure arises in the power train. The power train is formed by the engine system (for example, engine 11, fuel system, air system, ignition system), the transmission system (for example, transmission 13 and hydraulic pressure control circuit) and the MG system (for example, MG 12, inverter 18). The hybrid ECU 20 performs the failure-time clutch control by executing a failure-time clutch control routine shown in FIG. 2.

The failure-time control routine is repeated at a predetermined time interval while the hybrid ECU 20 is powered for operation. In this control routine, it is checked at step 101 whether an engine system failure flag Feg is set to 1, which indicates that any one of failure flags provided respectively for the fuel system, the air system and the ignition system in the engine 11 system indicates occurrence of failure. The engine system failure flag Feg is set to 1 (failure) or 0 (normal) by a conventional failure diagnosis routine (not shown) of the engine system.

If it is determined at step 101 that the failure flag Feg is 0 (no failure), step 102 is executed. At step 102, it is determined whether a transmission system failure flag Ftr is set to 1, which indicates that any one of failure flags provided respectively for the transmission 13 and the hydraulic pressure control circuit in the transmission 13 system indicates occurrence of abnormality. The transmission system failure flag Ftr is set to 1 (failure) or 0 (normal) by a conventional failure diagnosis routine (not shown) of the transmission system.

If it is determined at step 101 that the engine system failure flag Feg is set to 1 indicating a failure at some part (location) in the engine system or determined at step 102 that the transmission system failure flag Ftr is set to 1 indicating a failure at some part in the transmission system, it is determined that the engine system and/or the transmission system is not operating normally. In this case, step 103 is executed to change an operation mode to a limp-home mode (motor-driven travel mode) as a fail-safe operation. In this mode, the engine 11 is stopped and the wheels 16 are driven by only the drive power of the MG 12 for vehicle travel. After changing the operation mode, the clutch 17 is controlled to the drive power interruption state, that is, the clutch 17 disengages its input side and its output side. Thus, the engine 11 and the transmission 13 are protected from being driven by the drive power of the MG 12. The mode change to the limp-home mode may be executed at a different step other than step 103 or in a different routine (not shown).

If it is determined at step 101 that the engine system failure flag Feg is set to 0 indicating no failure at any parts (locations) in the engine system or determined at step 102 that the transmission system failure flag Ftr is also set to 0 indicating no failure at any parts in the transmission system, it is determined that both the engine system and the transmission system are operating normally. In this case, step 105 is executed to check whether a MG system failure flag Fmg is set to 1, which indicates that any one of failure flags provided respectively for the MG 12 and the inverter 18 in the MG system indicates occurrence of abnormality.

The MG system failure flag Fmg is set to 1 (failure) or 0 (normal) by a conventional failure diagnosis routine (not shown) of the MG system. If it is determined at step 105 that the MG system failure flag Fmg is set to 1, it is determined that a failure has occurred at least one part (location) in the MG system with no failure in the engine system and the transmission system, step 106 is executed to control the clutch 17 to the drive power transfer state. That is, the clutch 17 maintains engagement between its input side and its output side. Thus, the drive power of the engine 11 is transferred to the wheels 16 through the clutch 17.

If it is determined at step 105 that the MG system failure flag Fmg is set to 0 indicating no failure at any parts (locations) in the MG system, it is determined that the MG system is operating normally. The failure-time clutch control routine executed by the hybrid ECU 20 may alternatively executed by the transmission ECU 27 or by both of the hybrid ECU 20 and the transmission ECU 27.

According to the embodiment, when a failure arises in the engine system or the transmission system, which are at the input side of the clutch 17, the clutch 17 is switched to the drive power interruption state. As a result, even when the vehicle is driven by only the MG 12 in the limp-home mode, the engine 11 and the transmission 13 are protected from being driven by the MG 12. By thus reducing loss of energy, degradation of the dynamic operation performance of the vehicle and increase of the electric power consumption are suppressed. When the regenerative braking is applied, the engine 11 and the transmission 13 are protected from being driven in reverse, that is, from the output side to the input side. As a result, the regenerative braking is performed efficiently.

Further, when the MG system has a failure, the clutch 12 is controlled to maintain the drive power transfer state thereby to transfer the drive power of the engine 11 to the wheels 16 through the clutch 16. As a result, the vehicle is driven by the engine 11 to perform the limp-home operation. The arrangement of the MG 12 is not limited to the position between the transmission 13 and the differential gear set 14 in the power train from the engine 11 to the wheels 16. The MG 12 may be arranged to be coupled to the differential gear set 14, the drive axle 15, the wheels 16, for example, which are downstream the clutch 17 in the power train.

What is claimed is:

1. A drive control system for a vehicle, which has a power train including an internal combustion engine, a transmission and wheels, the drive control system comprising:
a motor-generator provided as a drive power source between the transmission and the wheels;
a clutch provided between the transmission and the motor-generator; and
a control unit configured to control an operation state of the clutch to either a drive power transfer state or a drive power interruption state in correspondence to a location of failure when a failure arises in the power train, which includes an engine system having the engine, a transmission system having the transmission and a motor-generator system having the motor-generator.

2. The drive control system according to claim 1, wherein:
the control unit is configured to control the clutch to the drive power interruption state when the failure arises in the engine system or the transmission system.

3. The drive control system according to claim 1, wherein:
the control unit is configured to control the clutch to the drive power transfer state when the failure arises in the motor-generator system.

4. The drive control system according to claim 2, wherein:
the control unit is configured to control the clutch to the drive power transfer state when the failure arises in the motor-generator system.
